(19) United States
(12) Patent Application Publication
(10) Pub. No.: US 2003/0226575 A1
(43) Pub. Date: Dec. 11, 2003

(54) Flossing tool

(76) Inventor: Chee Yin Lee, Hong Kong (HK)

Correspondence Address: Thomas E. Sisson, JACKSON WALKER L.L.P., 112 E. Pecan Street, Suite 2100, San Antonio, TX, 78205, US

(21) Appl. No.: 10/163,922

(22) Filed: Jun. 5, 2002

(51) Int. Cl. A61C 15/00

(52) U.S. Cl. 132/327

(57) ABSTRACT

A flossing tool, for use with flossing string, includes a handle portion having a first end and a second end and a head portion disposed at the first end of the handle portion. The head portion has first and second arms extending outwardly to first and second distal ends that are adapted to support flossing string therebetween. A tensioner is slidably disposed on the handle portion and includes a clamp portion for receiving the flossing string. The tensioner is movably between a first position wherein the flossing string is freely receivable in the clamp portion and a second position wherein the flossing string is secured in the clamp portion.

### BACKGROUND TO THE INVENTION

1. Field of the Invention

The invention relates to flossing teeth and in particular to flossing tools adapted to hold floss string to assist a person flossing teeth.

2. Background Information

Numerous flossing tools designed to hold flossing string are known. Examples are described in U.S. Pat. No. 6,209,550; U.S. Pat. No. 6,092,536; U.S. Pat. No. 5,782,250 and U.S. Pat. No. 5,482,466. A problem with these flossing tools, and many others, is that a high degree of skill and dexterity is required to manipulate the flossing string on the tool.

### SUMMARY OF THE INVENTION

It is an object of the present invention to provide a flossing tool that is easy to use, or which at least ameliorates problems with known flossing tools. It is a further object of the present invention to at least provide the public with a useful alternative.

According to a first aspect of the invention there is provided a flossing tool for use with flossing string, the flossing tool including:

a handle portion having a first end and a second end;

a head portion disposed at the first end of the handle portion, the head portion including a first arm extending outwardly to a first distal end and a second arm extending outwardly to a second distal end, the first and second distal ends adapted to support flossing string therebetween, and

a tensioner slidably disposed on the handle portion and movable between at least a first position and a second position, the tensioner including a clamp portion for receiving the flossing string wherein in the first position the flossing string is freely receivable in the clamp portion and in the second position the flossing string is secured in the clamp portion.

According to a second aspect of the invention there is provided a flossing tool for use with flossing string, the flossing tool including:

a handle portion having a first end and a second end;

a head portion disposed at the first end of the handle portion, the head portion including a first arm extending outwardly to a first distal end and a second arm extending outwardly to a second distal end, the first and second distal ends adapted to support flossing string therebetween,

a channel extending between the first and second ends of the handle portion, and

a tensioner slidably disposed within the channel and movable between at least a first position and a second position, the tensioner including a clamp portion for receiving the flossing string wherein in the first position the flossing string is freely receivable in the clamp portion and in the second position the flossing string is secured in the clamp portion.

Preferably, the first arm has a first groove for guiding the flossing string along it to the first distal end, and second arm has a second groove for guiding the flossing string along it to the second distal end.

Preferably, the first and second arms extend outwardly away from each other.

Preferably, the first and second arms are adapted to move inwardly towards each other.

Preferably, the handle portion has a channel extending from proximate its first end towards its second end, the channel being adapted to slidably receive the tensioner.

Further aspects of the invention will become apparent from the following description, which is given by way of example only.

### BRIEF DESCRIPTION OF THE DRAWINGS

Embodiments of the invention will now be described with reference to the accompanying drawings in which:

FIG. 1 illustrates a first perspective view of a flossing tool according to the invention,

FIG. 2 illustrates a second perspective view of the flossing tool,

FIG. 3 illustrates an exploded perspective view of the flossing tool,

FIG. 4 illustrates a plan view of a handle and head portion of the flossing tool,

FIG. 5 illustrates a side elevation view of the handle and head portion,

FIG. 6 illustrates a perspective view of a tensioner and clamp portion of the flossing tool,

FIG. 7 illustrates a locking portion of the tensioner,

FIG. 8 illustrates a sectional side elevation view of the handle and head portion with tensioner,

FIG. 9 is a first detailed illustration of area D of FIG. 8, and

FIG. 10 is a second detail illustration of area D of FIG. 8.

### DESCRIPTION OF THE PREFERRED EMBODIMENTS

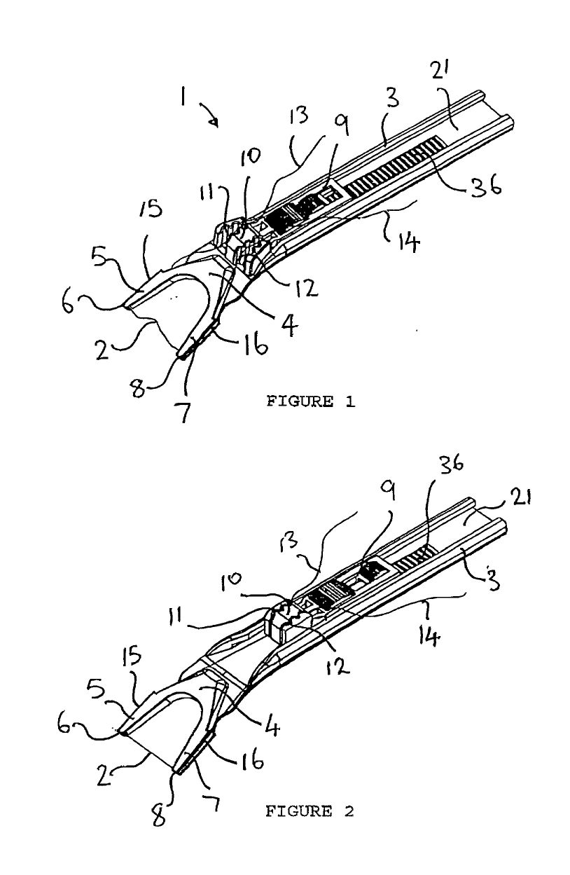

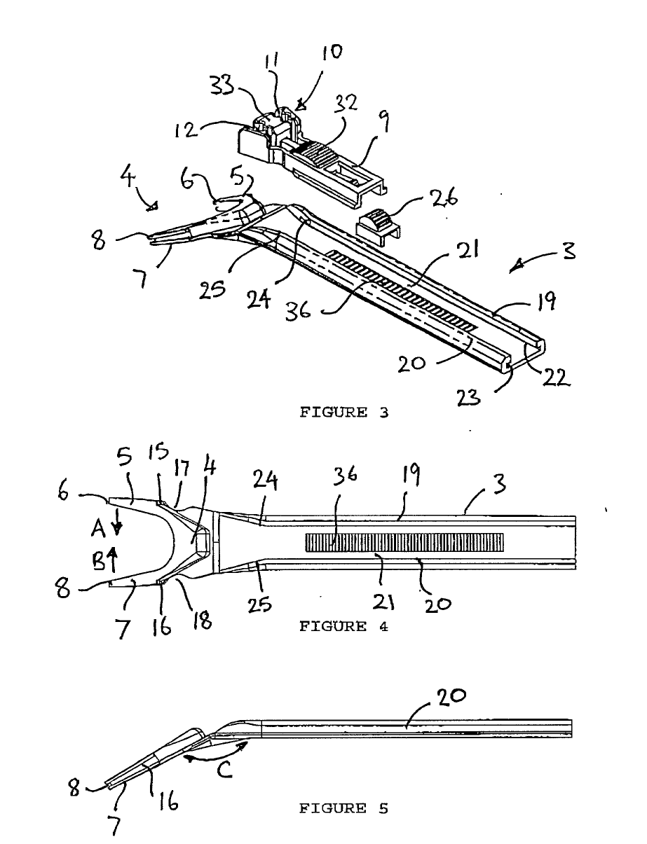

Referring to FIGS. 1 to 3, a flossing tool 1 for use with a length of flossing string 2 includes a handle portion 3 extending to a head portion 4 at its first end. The head portion 4 has a first arm 5 extending outwardly to a first distal end 6 and a second arm 7 extending outwardly to a second distal end 8. In use, the flossing string 2 is supported between the first and second distal ends 6, 8. The outer edge of each of first and second arm portions 5, 7 has a groove 15, 16 for guiding flossing string 2 along each arm 5, 7 to distal ends 6, 8.

A tensioner 9 is slidably disposed on the handle portion 3. The tensioner 9 includes a clamp 10 with side-by-side jaws 11, 12 through which end portions 13, 14 of the flossing 5 string 2 pass. Tensioner 9 is slidable between a first position adjacent head portion 4 as shown in FIG. 1 and a second position away from the head portion 4 as shown in FIG. 2.

Referring to FIGS. 4 and 5, the handle portion 3 and head portion 4 are integrally formed with head portion 4 orientated at an angle C from handle portion 3 to facilitate a comfortable operating position. The first and second arm members 6, 7 are integrally formed extensions of the head portion 4. In the preferred embodiment the first and second arm portions 6, 7 are formed to extend outwardly away from each other so that operating area between distal ends 6, 8 is greater than the nominal width of head portion 4.

The handle 3 and head 4 portions are made of well-known thermoplastic elastomeis (TPEs) to provide flexibility with good elastic recovery properties. When under tension first and second arms 6, 7 flex inwardly towards each other as shown by arrows A and B. To help facilitate the flex each arm 5, 6 has a semi-circular shaped notch 17, 18 at is proximal end adjacent head portion 4. When tension is released from arms 5, 6 they return to their outwardly extending positions.

The longitudinal edges 19, 20 of handle portion 3 are rolled upwardly and inwardly to form a channel 21, with grooves 22, 23 along its internal edges, longitudinally in the handle portion. Proximate the head portion 4 the channel 21 opens to a mouth with edges 19, 20 forming rounded entrance shoulders 24, 25. Within the floor of channel 21 are formed ‘saw-tooth’ shaped locking teeth 36.

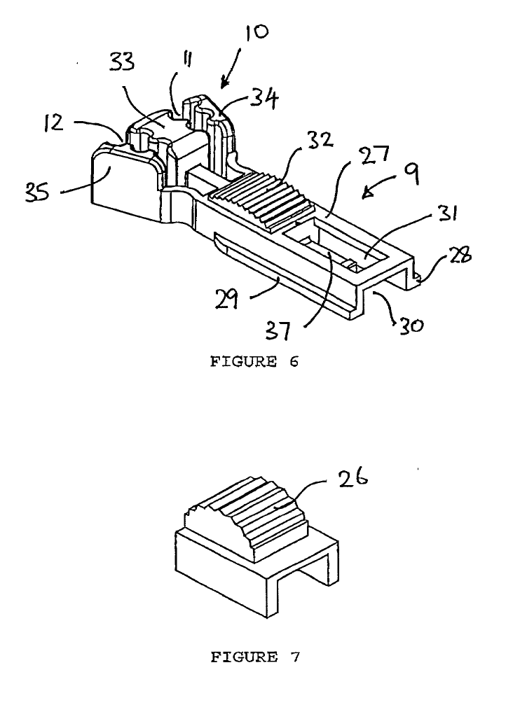

FIG. 6 illustrates detail of the tensioner 9. Tensioner 9 includes a locking member 26, which is illustrated in FIG. 7. Tensioner 9 comprises a body portion 27 extending to clamp 10 at one end. The tensioner 9 is also made from thermoplastic elastomeis (TPEs) to provide flexibility with good elastic recovery properties. Body portion 27 is formed with a substantially ‘hat’ shaped cross-section having outwardly extending guide rails 28, 29 along either edge. The end 30 of tensioner 9 is hollow thereunder and has an opening 31 for receiving locking member 26. Centrally on tensioner 9 is a grip portion 32 with which a user can slidably move tensioner 9 on handle portion 3. Extending from the grip portion 32 in to hollow end 30 is a locking tab 37.

The clamp 10 of tensioner 9 comprises a central body member 33 having wavelike mating surfaces formed in either side. Extending in an outwardly direction, away from each other, on either side of central body member 33 at two clamping arms 34, 35. The two clamping arms 34, 35 have corresponding wavelike mating surfaces and are deformably movable in an inwards direction so that their corresponding wavelike mating surface engages with the respective mating surface of central body member 33 to provide jaws 11, 12.

Tensioner 9 is slidably receivable within the channel 21 of handle portion 3. Guide rails 28, 29 of tensioner 9 slidably engage within grooves 22, 23 of channel 21. Tensioner 9 is slidably movable to a first position wherein clamp 10 extends beyond the mouth of channel 21 proximate head portion 4. In this position clamp arms 34, 35 are in their natural outwardly extending position opening jaws 11, 12 of clamp 10. In use, a length 2 of flossing string is drawn loosely between distal ends 6 and 8 of head arms 5 and 7. One end 13 of flossing string 2 is laid in the groove 15 of arm 5 and through open jaw 11 of clamp 10. The other end of 14 of flossing string 2 is laid in groove 16 of arm 7 and through open jaw 12 of clamp 10. This arrangement is illustrated in FIG. 1.

Referring again to FIG. 2, tensioner 9 can be slidably moved back along channel 21 of handle portion 3. As tensioner 9 is slidably moved clamp 10 is drawn into the mouth of channel 21. The shoulders 24, 25 of the mouth engage against clamp arms 34, 35 respectively closing jaws 11 and 12 to clamp ends 13, 14 of flossing string 2 therein. As tensioner 9 is slidably moved further along channel 21 tension is applied to flossing string 2 drawing it taught between distal ends 6, 8 of arms 5, 7. Arms 5, 7 flexibly deform inwardly under tension.

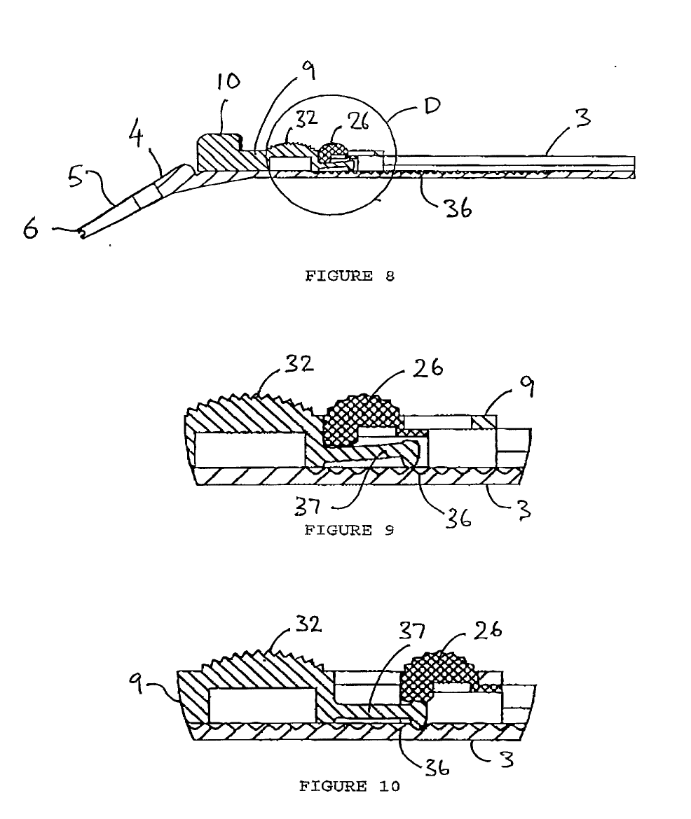

FIGS. 8 to 10 illustrate how lock 26 is slidably moved within hollow end 30 of tensioner 9 to cause locking tab 37 to engage with locking teeth 36. Locking member 26 is slidably moved to a position adjacent grip portion 32. In this position locking tab 37 is free to move over locking teeth 36 as tensioner 9 is slidably moved within channel 21. When the tensioner 9 has been moved to apply the desired attention to flossing string 2, locking member 26 is slidably moved away from the grip portion 32 causing locking tab 37 to engage with locking toothed 36 to lock tensioner 9 in position. Such locking arrangements are common in the art and a variety of methods are known. Typical examples are found in the wide variety of retractable blade utility knives common in the market.

The flossing tool of the invention is easy to operate and manipulate. When the flossing string between the distal ends 6, 8 of arms 5, 7 becomes dirtied the user may slidably move tensioner 9 forward, to release the jaws 11, 12 of clamp 10, and draw the flossing string 2 through the jaws 11, 12 to position a clean portion of flossing string 2 between distal ends 6, 8. Tensioner 9 is then slidably moved back again to retention the flossing string 2.

Where in the foregoing description reference has been made to integers or elements having known equivalents then such are included as if individually set forth herein.

Embodiments of the invention have been described, however it is understood that variations, improvement or modifications can take place without departure from the spirit of the invention or scope of the appended claims.

What is claim is:

1. A flossing tool for use with flossing string, the flossing tool including:
a handle portion having a first end and a second end;
a head portion disposed at the first end of the handle portion, the head portion including a first arm extending outwardly to a first distal end and a second arm extending outwardly to a second distal end, the first and second distal ends adapted to support flossing string therebetween, and
a tensioner slidably disposed on the handle portion and movable between at least a first position and a second position, the tensioner including a clamp portion for receiving the flossing string wherein in the first position the flossing string is freely receivable in the clamp portion and in the second position the flossing string is secured in the clamp portion.

2. A flossing tool as claimed in claim 1 wherein the first arm has a first groove for guiding the flossing string along it to the first distal end, and second arm has a second groove for guiding the flossing string along it to the second distal end.

3. A flossing tool as claimed in claim 1 wherein the first and second arms extend outwardly away from each other.

4. A flossing tool as claimed in claim 3 wherein the first and second arms are adapted to move inwardly towards each other.

5. A flossing tool as claimed in claim 1 wherein the handle portion has a channel extending from proximate its first end towards its second end, the channel being adapted to slidably receive the tensioner.

6. A flossing tool for use with flossing string, the flossing tool including:
a handle portion having a first end and a second end;
a head portion disposed at the first end of the handle portion, the head portion including a first arm extending outwardly to a first distal end and a second arm extending outwardly to a second distal end, the first and second distal ends adapted to support flossing string therebetween,
a channel extending between the first and second ends of the handle portion, and
a tensioner slidably disposed within the channel and movable between at least a first position and a second position, the tensioner including a clamp portion for receiving the flossing string wherein in the first position the flossing string is freely receivable in the clamp portion and in the second position the flossing string is s secured in the clamp portion.

7. A flossing tool as claimed in claim 6 wherein the first arm has a first groove for guiding the flossing string along it to the first distal end, and second arm has a second groove for guiding the flossing string along it to the second distal end.

8. A flossing tool as claimed in claim 6 wherein the first and second arms extend outwardly away from each other.

9. A flossing tool as claimed in claim 6 wherein the first and second arms are adapted to move inwardly towards each other.
